(19) United States
(12) Patent Application Publication
(10) Pub. No.: US 2016/0313815 A1
(43) Pub. Date: Oct. 27, 2016

(54) INPUT DEVICE FOR ELECTRONIC DEVICE

(71) Applicant: Samsung Electronics Co., Ltd., Gyeonggi-do (KR)

(72) Inventor: Sung-Yeon LEE, Gyeonggi-do (KR)

(73) Assignee: Samsung Electronics Co., Ltd.

(21) Appl. No.: 15/137,432

(22) Filed: Apr. 25, 2016

(30) Foreign Application Priority Data
Apr. 24, 2015 (KR) 10-2015-0057984

(51) Int. Cl. G06F 3/0354; B43K 29/18; G06F 3/046; G06F 3/038; G06F 3/044; G06F 3/041

(52) U.S. Cl. CPC G06F 3/03545; G06F 3/044; G06F 3/0412; G06F 3/046; G06F 3/038; B43K 29/18

(57) ABSTRACT

Disclosed is an input device of an electronic device, including a body, a first input member that is arranged to be linearly movable within the body, and a second input member that is arranged to be linearly movable within the body, and is coupled to the first input member, wherein, as a first portion of the body is rotated in a first direction, the first and second input members linearly move in unison and cause the first input member to protrude from a first end of the body, and wherein, as a second portion of the body is rotated in an opposite direction to the first direction, the first and second input members linearly move in unison and cause the second input member to protrude from a second end of the body.

### PRIORITY

This application claims priority under 35 U.S.C. §119(a) to Korean Patent Application Serial no. 10-2015-0057984, which was filed in the Korean Intellectual Property Office on Apr. 24, 2015, the contents of which are incorporated herein by reference.

### BACKGROUND

1. Field of the Disclosure

The present disclosure relates generally to an input device, and more particularly, to an input device for use in an electronic device.

2. Description of the Related Art

An electronic device performs specific functions according to programs such as an electronic scheduler, a portable multimedia reproducer, a mobile communication terminal, a tablet personal computer (PC), an image/sound device, a desktop/laptop computer, a home appliance, and a vehicular navigation system, incorporated in the electronic device. For example, such electronic devices may output stored information as a sound or an image. As the integration of electronic devices has increased and super-high speed and large capacity wireless communication has become more popular, various functions have recently been incorporated into a single mobile communication terminal.

For example, in addition to a communication function, an entertainment function such as a game, a multimedia function such as music/video image reproduction, a communication and security function for mobile banking, and a schedule management or an electronic wallet function, are integrated into a single electronic device. A portable electronic device such as an electronic scheduler, a portable multimedia reproducer, a mobile communication terminal, or a tablet personal computer (PC) is generally equipped with a display device and a battery, and has a bar-type, folder-type, or sliding-type appearance depending on the shape of the display device or the battery.

There are various types of input devices for such an electronic device. For example, a desktop computer is provided with a keyboard or a mouse, and a home appliance may be provided with a remote controller. In a mobile communication terminal, a microphone or a keypad has been used as a typical input device, and a touch screen has recently replaced a physical keypad, to serve as both an input module that receives input data by sensing a user's touch and a display unit that displays a screen of the electronic device. The touch screen is capable of detecting a touch from a part of the user's body, such as a finger, through a touch panel that is implemented in an electrostatic capacitive type or a resistive film type.

The electronic device is equipped with a panel in which is embedded a resonance circuit, such as a digitizer, and an input method may be implemented using a digital pen corresponding to the resonance circuit embedded in the panel. For example, the user may express and input a handwritten letter or a sketch in more detail through an input device using the digital pen than by using the electrostatic capacitive or the resistive film touch panel.

Meanwhile, the user typically handwrites a letter or sketches on an intermediate medium, such as paper, using a fountain or ball point pen, or a pencil. When using the digital pen, the user may directly input a handwritten letter to the electronic device in a similar manner of entering an input to an analog medium.

However, when a digital pen is implemented to be portable when mounted in a portable electronic device, an analog pen in the prior art has to be separately transported, which is an inconvenience to the user.

As such, there is a need in the art for an improved configuration of the digital and analog pen implementation for an electronic device.

### SUMMARY

The present disclosure has been made to address the above-mentioned problems and disadvantages, and to provide at least the advantages described below.

Accordingly, an aspect of the present disclosure is to provide an input device for an electronic device in which a digital pen and an analog pen are configured as a single body so that the input device can be easily miniaturized while being conveniently transported.

Another aspect of the present disclosure is to provide an input device for an electronic device that enables an electrostatic capacitive type or resonant type touch input.

According to an aspect of the present disclosure, an input device of an electronic device includes a body, a first input member that is arranged to be linearly movable within the body, and a second input member that is arranged to be linearly movable within the body, and is coupled to the first input member, wherein, as a first portion of the body is rotated in a first direction, the first and second input members linearly move in unison and cause the first input member to protrude from a first end of the body, and wherein, as a second portion of the body is rotated in an opposite direction to the first direction, the first and second input members linearly move in unison and cause the second input member to protrude from a second end of the body.

According to another aspect of the present disclosure, an electronic device includes an input device, wherein the input device includes a body, a first input member that is arranged to be linearly movable within the body, and a second input member that is arranged to be linearly movable within the body, and is coupled to the first input member, wherein, as a first portion of the body is rotated in a first direction, the first and second input members linearly move in unison and cause the first input member to protrude from a first end of the body, and wherein, as a second portion of the body is rotated in an opposite direction to the first direction, the first and second input members linearly move in unison and cause the second input member to protrude from a second end of the body.

### BRIEF DESCRIPTION OF THE DRAWINGS

The above and other aspects, features, and advantages of the present disclosure will be more apparent from the following detailed description taken in conjunction with the accompanying drawings, in which:

FIG. 1 is a front perspective view illustrating an electronic device according to embodiments of the present disclosure;

FIG. 2 is a rear perspective view illustrating the electronic device according to embodiments of the present disclosure;

FIG. 3 is a sectional view illustrating a display device of the electronic device according to embodiments of the present disclosure;

FIG. 4 illustrates a configuration of an input device of the electronic device according to embodiments of the present disclosure in a disassembled state;

FIG. 5 illustrates a first input member and a second input member of an input device according to embodiments of the present disclosure while the first and second input members are coupled to each other;

FIG. 6 is a perspective view illustrating the binding recess of the first input member and the binding portion of the second input member of the input device according to embodiments of the present disclosure;

FIG. 7 is a side view illukrating the first input member of the input device according to embodiments of the present disclosure partially in cross section when the first input member protrudes from a first end of the body;

FIG. 8 is a side view illustrating the input device according to embodiments of the present disclosure partially in cross section when a cap is coupled to a second end of the body;

FIG. 9 is a side view illustrating the input device according to embodiments of the present disclosure partially in cross section when the cap is coupled to the first end of the body;

FIG. 10 is a side view illustrating the first input member of the input device according to embodiments of the present disclosure partially in cross section when the first input member protrudes from the second end of the body;

FIG. 11 is a side view the input device according to embodiments of the present disclosure partially in cross section when the cap is coupled to the first end of the body; and

FIG. 12 is a side view illustrating the input device according to embodiments of the present disclosure partially in cross section when the cap is coupled to the second end of the body.

### DETAILED DESCRIPTION OF EMBODIMENTS OF THE DISCLOSURE

Hereinafter, embodiments of the present disclosure will be described with reference to the accompanying drawings. However, it should be understood that there is no intent to limit the present disclosure to the particular forms disclosed herein; rather, the present disclosure should be construed to cover various modifications, equivalents, and/or alternatives of embodiments of the present disclosure. In describing the drawings, similar reference numerals may be used to designate similar constituent elements. Descriptions of well known functions and configurations will be omitted for the sake of clarity and conciseness.

In the present disclosure, the expressions “have”, “may have”, “include” and “may include” refer to the existence of a corresponding numerical value, function, operation, or element, and do not exclude existence of additional features.

In the present disclosure, the expressions “A or B”, “at least one of A or/and B”, and “one or more of A or/and B” may include all possible combinations of the items listed. For example, these expressions may refer to all of (1) including at least one A, (2) including at least one B, or (3) including all of at least one A and at least one B.

The expressions “a first”, “a second”, “the first”, or “the second” used in embodiments of the present disclosure may modify various components regardless of the order and/or the importance but does not limit the corresponding components. For example, a first user device and a second user device indicate different user devices although both are user devices. Furthermore, a first element may be referred to as a second element, and similarly, a second element may be referred to as a first element without departing from the scope of the present disclosure.

It should be understood that when an element, such as a first element, is referred to as being operatively or communicatively “connected” or “coupled” to another element, such as a second element, it may be directly connected or coupled directly to the second element or a third element may be interposed between the first and second elements. In contrast, it may be understood that when a first element is referred to as being “directly connected,” or “directly coupled” to a second element, there is no third element interposed between the first and second elements.

The terms used herein are merely for the purpose of describing particular embodiments and are not intended to limit the scope of other embodiments. As used herein, singular forms may include plural forms as well unless the context clearly indicates otherwise. Unless defined otherwise, all terms used herein, including technical and scientific terms, have the same meanings as those commonly understood by a person skilled in the art to which the present disclosure pertains. Such terms as those defined in a generally used dictionary may be interpreted to have the same meanings as the contextual meanings in the relevant field of art, and are not to be interpreted to have ideal or excessively formal meanings unless clearly defined in the present disclosure. In some cases, even terms defined in the present disclosure are not to be interpreted to exclude embodiments of the present disclosure.

According to the present disclosure, since the input device of an electronic device is configured such that the first input member and the second input member are received in the body to be linearly movable, the user can use each of the first input member and the second input member as needed. When the input device includes a cap that is selectively coupled to any opposite ends of the body, an end of the first input member or the second input member, which protrudes from the body, can be protected. Furthermore, when the cap is provided with a third input member, an input signal may be generated in a manner different from the second input member.

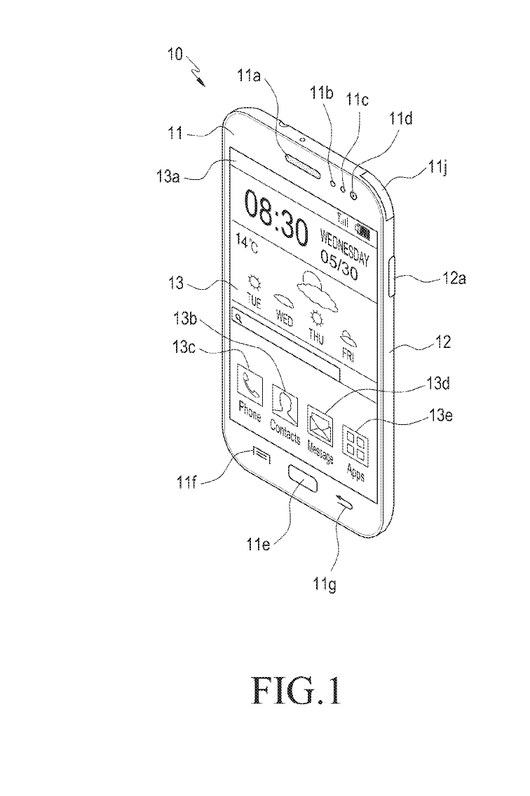

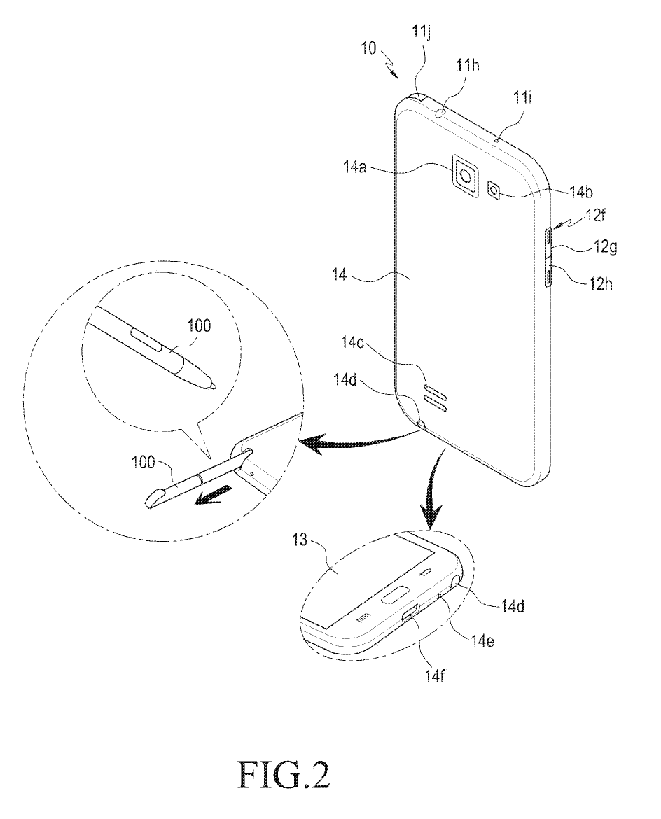

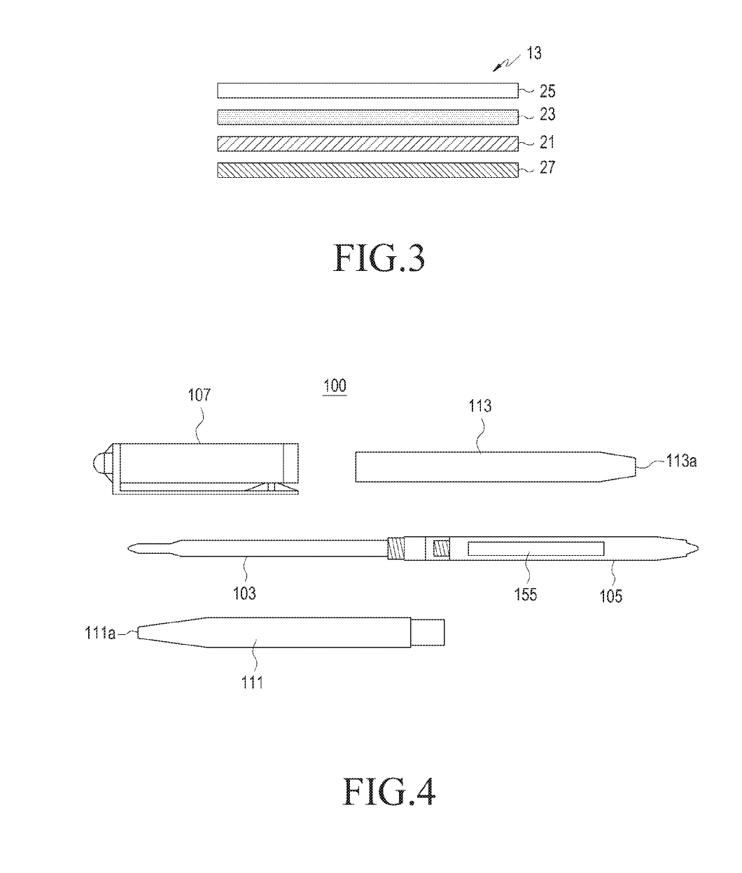

FIG. 1 is a front perspective view illustrating an electronic device according to embodiments of the present disclosure. FIG. 2 is a rear perspective view illustrating the electronic device according to embodiments of the present disclosure. FIG. 3 is a sectional view illustrating a display device of the electronic device according to embodiments of the present disclosure.

Referring to FIGS. 1 to 3, a display device 13 may be disposed on a front surface 11 of the electronic device 10 where it displays a main home screen. When the power of the electronic device 10 is turned on, the main home screen may be displayed on the electronic device 10. When the electronic device 10 has several pages of different home screens, the main home screen may be the first home screen to be displayed. Shortcut icons 13b, 13c, and 13d for executing frequently used applications, a main menu switch key such as ‘Apps 13e’ which is the icon used to switch to the screen for managing applications, time, and weather, may be displayed on the main menu screen. When a user selects the main menu switch key such as apps 13e, a menu screen may be displayed on the display device 13. Also, displayed in the upper end portion of the display device 13 are status bars 13a, which indicate a battery charge state, an intensity of a radio wave signal received from a base station or a repeater, and the current time, for example.

A home button 11e, a menu button 11f, and a back button 11g may be formed in the lower portion of the display device 13. The home button 11e may cause the main home screen of the display device 13 to be displayed. For example, the display device 13 displays the main home screen when the home button 11e is selected when 10 the display device 13 displays a home screen that is different from the main home screen or the menu screen. The main home screen illustrated in FIG. 1 is displayed on the display device 13 when the home button 11e is selected while the applications are being executed on the display device 13.

The home button 11e may cause recently used applications to be displayed on the display device 13. The menu button 11f may provide a connection menu that is capable of being displayed on the display device 13. A widget addition, background screen change, retrieve, edition, or environment setting menu may be configured in the connection menu. The back button 11g may be used in order to cause a screen, which was executed just before the currently executed screen, to be displayed, or to terminate the most recently used application.

A first speaker 11a, an illuminance sensor 11b, a proximity sensor 11c, and a first camera 11d may be arranged near an edge of the front surface 11 of the electronic device 10. As illustrated in FIG. 2, a second camera 14a, a flash 14b, and a second speaker 14c may be arranged on the rear surface 14 of the electronic device 10. A power/lock button 12a, a volume button 12f having a volume increase button 12g and a volume decrease button 12h, a terrestrial digital multimedia broadcasting (DMB) antenna for receiving broadcasting 11j, and one or more mics 11i and 14e, may be arranged on the lateral side surfaces 12 of the electronic device 10.

A connector 14f is formed on the lower end side surface of the electronic device 10. A plurality of electrodes may be formed in the connector 14f to be electrically connected with an external device. An earphone connection jack 11h may be formed on the upper end side surface of the electronic device 10. A connection terminal of an earphone is insertable into the earphone connection jack 11h.

An input device 100 may be inserted into the lower end side surface of the electronic device 10, and may be removed or separated from the electronic device 10 when the input device 100 is in use.

As illustrated in FIG. 3, the electronic device 10 may be provided with a separate digitizer 27 as an input panel in order to detect content that is written by the input device 100. The digitizer 27 may detect the written content using the input device 100 and may transmit the written content to the electronic 10 while communicating with the electronic device 10 in a wired or wireless manner. The digitizer 27 may be made of a foldable, flexible panel.

An electromagnetic field is formed when an alternating current is applied to the digitizer 27 serving as an input panel. When a user brings the input device 100 closer to the digitizer 27, a current may be formed in an induction coil of the input device 100 by the electromagnetic field of the digitizer 27, and an electromagnetic field may be formed through a circuit unit that is provided in the input device 100. When writing is performed using the input device 100 in which the electromagnetic field is formed, the digitizer 27 may detect a moving trace of the input device 100 so as to convert the written content into an electronic file. The digitizer 27 may transmit the electronic file to the electronic device 10 through wired or wireless communication.

The digitizer 27 may be incorporated into the display device 13 of the electronic device 10. In this case, an input panel combined with the input device 100 may be the display device 13 of the electronic device 10, and the display device 13 itself may operate as an input panel that is capable of detecting the written content of the input device 100.

A window member 25, such as a glass member, may be disposed on the outer surface of the display device 13, and a display module 21, such as a liquid crystal display module, may be disposed on the inner surface of the display device 13. A touch panel 23 may be interposed between the window member 25 and the display module 21 when the display device 13 has an electrostatic capacitive touch screen function. The touch panel 23 may be formed of transparent electrodes that are formed on a transparent synthetic resin film using an indium-tin oxide. The touch panel 23 may be implemented in an electrostatic capacitive type. The display device 13 includes the digitizer 27 inside the display module 21 so that the display device 13 may detect a writing input performed using the input device 100.

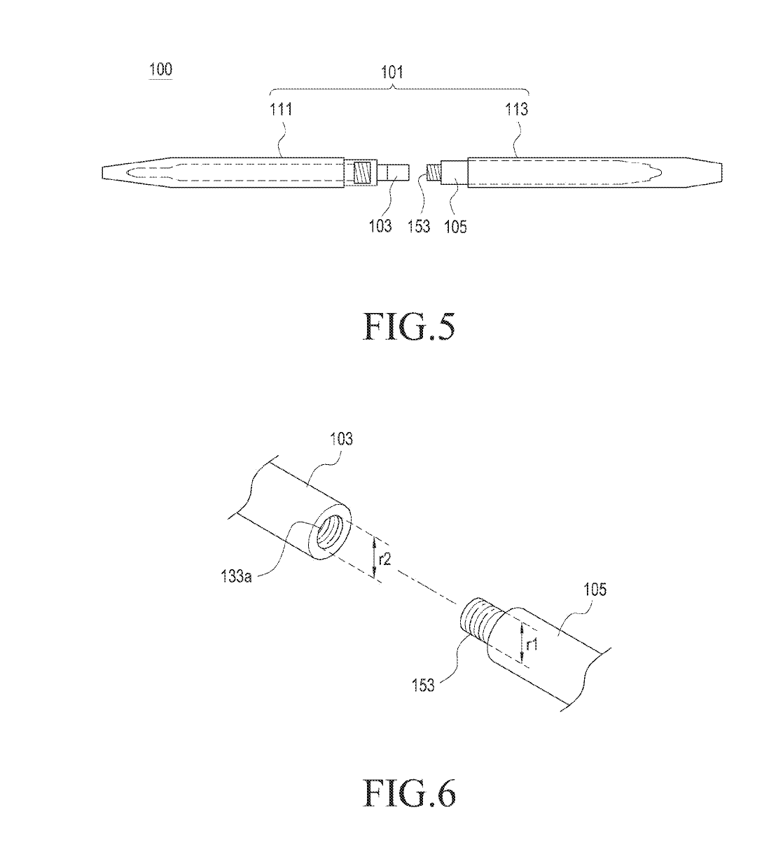

FIG. 4 illustrates a disassembled configuration of an input device of the electronic device according to embodiments of the present disclosure. FIG. 5 illustrates a first input member and a second input member of an input device according to embodiments of the present disclosure. FIG. 6 is a perspective view illustrating the binding recess of the first input member and the binding portion of the second input member of the input device according to embodiments of the present disclosure.

Referring to FIGS. 4 to 6, the input device 100 may include a body 101, a first input member 103, and a second input member 105.

The body 101 may include a first body portion 111 in which the first input member 103 is accommodated, and a second body portion 113 in which the second input member 105 is accommodated. The first body portion 111 and the second body portion 113 may be rotatably coupled to each other.

The first input member 103 may be linearly moved within the body 101 by the relative rotation of the second body portion 113 in relation to the first body portion 111. The first input member 103, such as a ball point pen or a pencil, enables writing on an intermediate medium including paper.

The second input member 105 may be coupled with the first input member 103 and may be linearly moved within the first body portion 111 together with the first input member. For example, the body 101 is connected with the first input member 103 and the second input member 105, and the rotating movement of the body 101, i.e., the relative rotation of the second body portion 113 in relation to the first body portion 111, may be converted into a linear movement of the first and second input members 103 and 105.

In the second input member 105, the electromagnetic field formed in the electronic device may be received to generate an induction current, and an electromagnetic field according to the generated induction current may be formed. For example, the second input member 105 may include a circuit unit 155, illustrated in FIG. 4, which is equipped with a coil and a capacitor, the electromagnetic field formed in the electronic device may generate an induction current in the coil, and the generated induction current may be charged to the capacitor. The current charged to the capacitor may be discharged through the coil to form an electromagnetic field, and the digitizer 27 senses the electromagnetic field so as to detect the position of the second input member 105.

The input device 100 may further include a cap 107, illustrated in FIG. 4, that is selectively coupled to an opposite end of the body 101 and a third input device 171 provided in the cap 107, as illustrated in FIG. 8, which will be further described below.

As illustrated in FIG. 4, a first end 111a, which is at one end of the body 101, may be formed to correspond to a second end 113a, which is at an opposite end of the body 101. The cap 107 may be fitted on and enclose the first end 111a or the second end 113a of the body 101. The third input device 171 may be formed of a conductive material, may be provided on the cap 107, and may be brought closer to the display device 13 that performs the electrostatic capacitive touch screen function so as to cause the touch panel 23 to generate an input signal.

The first input member 103 is detachable from/attachable to the second input member 105 to be replaced from the input device 100. As illustrated in FIG. 6, the first input member 103 is formed with a binding recess 133a in which threads are formed, and the second input member 105 is formed with a binding portion 153 to be screw-coupled to the binding recess 133a so that the first input member 103 and the second input member 105 may be coupled to/separated from each other. However, the binding portion 153 may alternatively be fitted to the binding recess 133a, as well.

For example, the binding portion 153 has an outer diameter r1 and is formed of a metal or a rigid material, and the binding recess 133a has an inner diameter r2 that is smaller than the outer diameter r1 and is formed of rubber or a material that is softer than that of the binding portion 153 so that the binding portion 153 may be fitted to the binding recess 133a. While the present embodiment discloses a configuration in which the first input member 103 is formed with the binding recess 133a and the second input member 105 is formed with the binding portion 153, the opposite could occur in which the first input member 103 may be formed with the binding portion and the second input member 105 may be formed with the binding recess, or each of the first input member 103 and the second input member 105 could be formed with the binding recess and a separate binding portion may be provided.

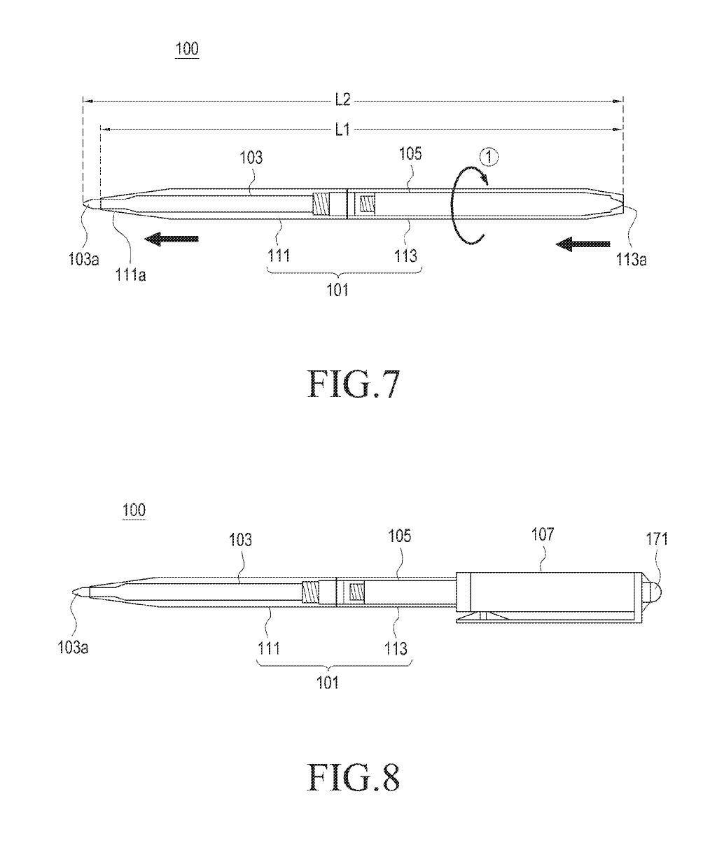

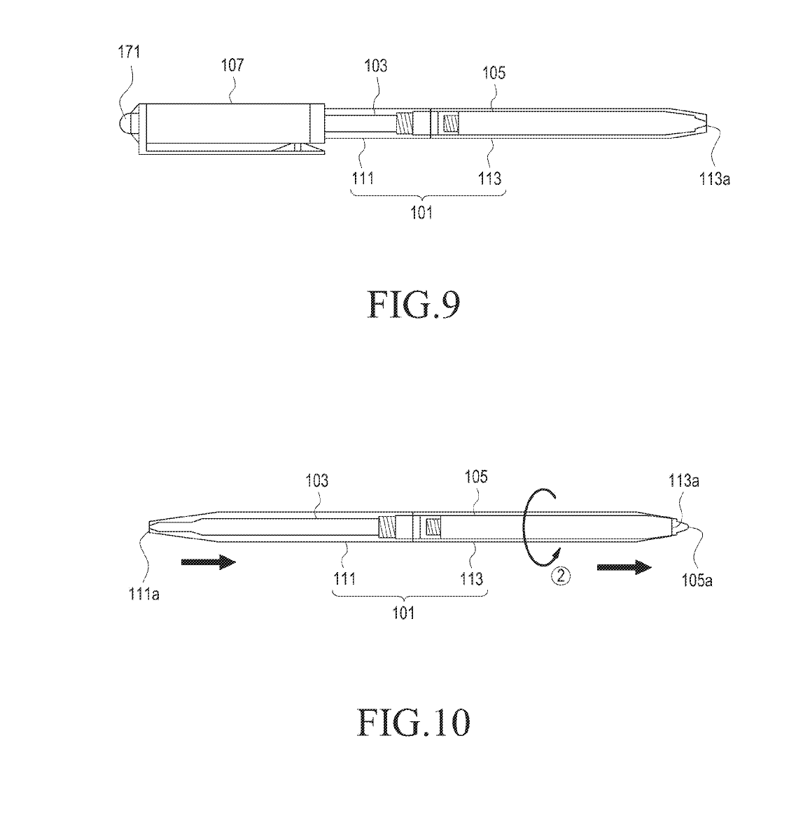

FIG. 7 is a side view illustrating the first input member of the input device according to embodiments of the present disclosure partially in cross section when the first input member protrudes from a first end of the body. FIG. 8 is a side view illustrating the input device according to embodiments of the present disclosure partially in cross section when a cap is coupled to a second end of the body. FIG. 9 is a side view illustrating the input device according to embodiments of the present disclosure partially in cross section when the cap is coupled to the first end of the body.

Referring to FIG. 7, when a second body portion 113 of the body 101 is rotated in a first direction \textcircled{1} in relation to the first body portion 111, an end 103a of the first input member 103 may protrude from the first end 111a of the body 101. The second input member 105 may be received within the body 101 as the second body portion 113 is rotated in the first direction \textcircled{1}. As a result, the second input member 105 is maintained in a stored state in the body 101, and the user may write desired contents on an intermediate medium, such as a paper, using the first input member 103.

As illustrated in FIG. 10 which will be described in detail below, a second length L2, which is the sum of the length of the first input member 103 and the length of the second input member 105, is set to be longer than a first length L1 of the body 101 so that the first end 103a of the first input member 103 or a first end 105a of the second input member 105 may protrude from the body 101. With this configuration, the input device may allow the first input member 103 to protrude from the first end 111a of the body 101 with less rotation as compared to when the first length L1 and the second length L2 are equal to each other.

Referring back to FIG. 8, the cap 107 is coupled to the second end 113a of the body 101 so that the user may use the third input device 171 together with the first input member 103. The cap 107 may safely protect the first end 105a of the second input member 105 received in the body 101.

Referring to FIG. 9, the cap 107 is coupled to the second end 113a of the body 101 so as to safely protect the first end 103a of the first input member 103 protruding from the first end 111a of the body 101. The user may generate an electrostatic capacitive input signal using the third input device 171 of the cap 107 that is coupled to the second end of the body 101.

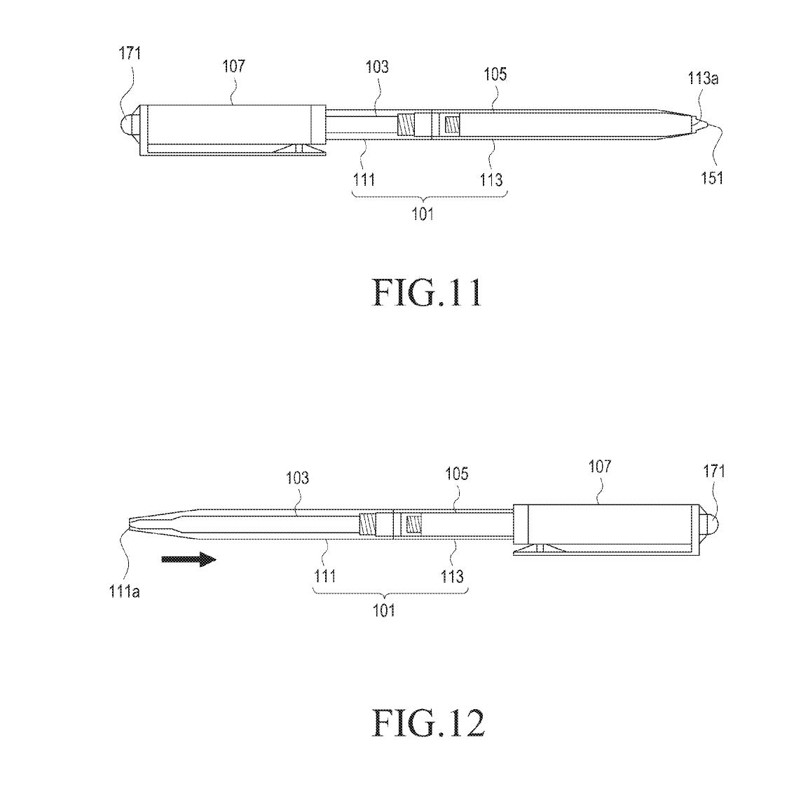

FIG. 10 is a side view illustrating the first input member of the input device according to embodiments of the present disclosure partially in cross section when the first input member protrudes from the second end of the body. FIG. 11 is a side view of the input device according to embodiments of the present disclosure partially in cross section when the cap is coupled to the first end of the body. FIG. 12 is a side view illustrating the input device according to embodiments of the present disclosure partially in cross section when the cap is coupled to the second end of the body.

Referring to FIG. 10, when the second body portion 113 of the body 101 is rotated with respect to the first body portion 111 in an opposite direction \textcircled{2} to the first direction \textcircled{1}, the second input member 105 may protrude from the second end 113a of the body 101. The first input member 103 may be received in the inside of the body 101 as the second body portion 113 is rotated in the opposite direction \textcircled{2}. As a result, the first input member 103 is maintained in a stored state in the body 101, and the user may generate an input signal to the electronic device 10 using the second input member 105.

Referring to FIG. 11, the cap 107 is coupled to the first end 111a of the body 101 so that the user may generate an electromagnetic resonant input signal using a third input device 171 that protrudes from the second end 113a of the body 101 or may generate an electrostatic capacitive input signal using the third input device 171 of the cap 107 that is coupled to the first end 111a of the body 101.

The cap 107 may safely protect the first end of the first input member 103 that is received in the body 101.

Referring to FIG. 12, the cap 107 may be coupled to the second end 113a of the body 101 so as to safely protect the second end 113a of the second input member 105 that protrudes from the second end 113a of the body 101. The user may generate an electrostatic capacitive input signal using the third input device 171 of the cap 107 that is coupled to the first end 111a of the body 101.

While the present disclosure has been shown and described with reference to certain embodiments thereof, it will be understood by those skilled in the art that various changes in form and details may be made therein without departing from the spirit and scope of the present disclosure as defined by the appended claims.

What is claimed is:

1. An input device of an electronic device, the input device comprising:
a body;
a first input member that is arranged to be linearly movable within the body; and
a second input member that is arranged to be linearly movable within the body, and is coupled to the first input member,
wherein, as a first portion of the body is rotated in a first direction, the first and second input members linearly move in unison and cause the first input member to protrude from a first end of the body, and
wherein, as a second portion of the body is rotated in an opposite direction to the first direction, the first and second input members linearly move in unison and cause the second input member to protrude from a second end of the body.

2. The input device of claim 1, wherein the second input member is resonant with the electronic device.

3. The input device of claim 1, wherein the second input member is received in the body as the first portion of the body is rotated in the first direction, and
wherein the first input member is received in the body as the second portion of the body is rotated in the opposite direction to the first direction.

4. The input device of claim 1, further comprising:
a cap that is selectively coupled to the first end or the second end of the body, and
a third input member that is provided on the cap and provides an input to the electronic device in an electrostatic capacitive manner.

5. The input device of claim 1, wherein a total length of the first and second input members is longer than a total length of the body.

6. The input device of claim 1, wherein the first input member is used for writing on an intermediate medium.

7. The input device of claim 6, wherein the intermediate medium includes paper.

8. The input device of claim 1, wherein the first input member is detachable from and attachable to the second input member.

9. The input device of claim 8, wherein one end of the first input member and one end of the second input member are fitted to each other.

10. An electronic device, comprising:
an input device, wherein the input device includes:
a body;
a first input member that is arranged to be linearly movable within the body; and
a second input member that is arranged to be linearly movable within the body, and is coupled to the first input member,
wherein, as a first portion of the body is rotated in a first direction, the first and second input members linearly move in unison and cause the first input member to protrude from a first end of the body, and
wherein, as a second portion of the body is rotated in an opposite direction to the first direction, the first and second input members linearly move in unison and cause the second input member to protrude from a second end of the body.

11. The electronic device of claim 10, further comprising:
a display device into which a digitizer corresponding to the second input member is incorporated.

12. The electronic device of claim 11, wherein the digitizer forms a first electromagnetic field, and the second input member is excited by the first electromagnetic field and forms a second electromagnetic field.

13. The electronic device of claim 12, wherein the digitizer detects the electromagnetic field formed by the second input member and generates an input signal.

14. The electronic device of claim 10, further comprising:
a display device into which an electrostatic capacitive touch panel is incorporated.
